(19) United States
(12) Patent Application Publication
(10) Pub. No.: US 2008/0108030 A1
(43) Pub. Date: May 8, 2008

(54) LINEAR EQUATION LEARNING AID

(76) Inventor: Tina Bates Bayne, Cincinanti, OH (US)

Correspondence Address: WOOD, HERRON & EVANS, LLP, 2700 CAREW TOWER, 441 VINE STREET, CINCINNATI, OH, 45202, US

(21) Appl. No.: 11/537,069

(22) Filed: Sep. 29, 2006

(51) Int. Cl. G09B 19/02

(52) U.S. Cl. 434/188

(57) ABSTRACT

A learning aid for teaching students linear equations. The learning aid includes a first display and a second display positioned upon a substrate. The first display includes a graph having an X and Y-axis with increments and lines that form a grid. A plurality of fasteners arranged along the graph represents the two-dimensional graphical illustration of the linear equation. The second display includes a plurality of markings arranged into layers that represent different one-dimensional mathematical representations of the linear equation under study. The learning aid is reusable for different equations. In one embodiment, the markings have a unique color corresponding to a numerical value.

### TECHNICAL FIELD

The technical field discussed relates to learning aids. In particular, a learning aid for helping students learn linear equations is discussed.

### BACKGROUND

Algebra is a challenging subject for many students and is required by a majority of educational curriculums today. One of the fundamental concepts of algebra is the linear equation. A linear equation has two variables and a constant related to each other either through a sum or difference. Reference to FIG. 1 illustrates a graphical representation of a linear equation. As one illustrative example, the linear equation represented in FIG. 1 is X+Y=10. The linear equation X+Y=10 is plotted in a two dimensional Cartesian set of coordinates with the X value plotted in a generally horizontal direction and the Y value plotted in a generally vertical direction. FIG. 1 illustrates that the path taken by the linear equation, plotted by adjusting the values for X and Y, generally travels from a point on the Y axis where Y=10 and X=0 to a point on the X axis where X=10 and Y=0. Of course, these values can continue further if negative X or Y values are used but are omitted here for the sake of brevity. Many students find it very difficult to grasp the concept of the linear equation. Particularly, varying the values of both X and Y is commonly not intuitively grasped by the student.

The traditional curriculum uses a combination of a lecture and a textbook with example problems and solutions. Such a technique is effective for teaching linear equations, however, it still suffers from different drawbacks. For instance, these traditional methods generally only stimulate a student visually or auditorally. Research has shown that engaging additional types of sensory inputs during learning increases the probability that the student grasps the concept. As an example, a student learns significantly more about an orange using all the senses rather than just one or two. Simply viewing the orange and hearing the sound that an orange makes when squeezed provides a limited understanding of an orange. Conversely, if the student also felt the roughness of the outer edges of the orange, smelled the citrus aroma, and sampled the sweet taste, additional understanding would occur. Similarly, the traditional method of teaching linear equations limits types of input, and therefore, the concept often escapes the grasp of the student. Accordingly, a need exists for improved learning aids.

### SUMMARY

The invention provides a kit for teaching linear equations. The kit includes a substrate having a first display and a second display. The first display includes a two-dimensional Cartesian graph. The second display includes a placemat. The kit also includes a set of indicators adapted to be placed on the two-dimensional Cartesian graph. The set of indicators graphically illustrate the linear equation on the two-dimensional Cartesian graph. The kit also includes a set of markers each having a length corresponding to a numerical value. The set of markers are adapted to be on the placemat in a position to illustrate the linear equation in one dimension.

The invention further provides a method for teaching linear equations using a learning aid. The method includes arranging a first set of indicators to graphically represent a linear equation in two mathematical dimensions on a first display. The method also includes arranging a second set of indicators representing a constant numerical value on a second display, wherein arrangement of the second set of indicators graphically corresponds with the linear equation in one dimension, wherein both graphical representations on the first display and the second display are displayed simultaneously on a substrate.

The invention also provides a device for teaching linear equations. The device includes a substrate including a first display and a second display. The device also includes a first graphical representation of the linear equation located on the first display including a line placed on a two-dimensional Cartesian coordinate graph. The device also includes a second graphical representation of the linear equation positioned side-by-side to the first graphical representation on the second display. The second graphical representation includes markers having a length representative of a numerical value. The markers are arranged linearly to represent the linear equation.

### BRIEF DESCRIPTION OF THE DRAWINGS

The accompanying drawings, which are incorporated in and constitute a part of this specification, illustrate one or more embodiments and, together with the general description given above and the detailed description given below, serve to explain the embodiments.

FIG. 1 illustrates a schematic view of a linear equation that represents an already known graphical illustration of the linear equation;

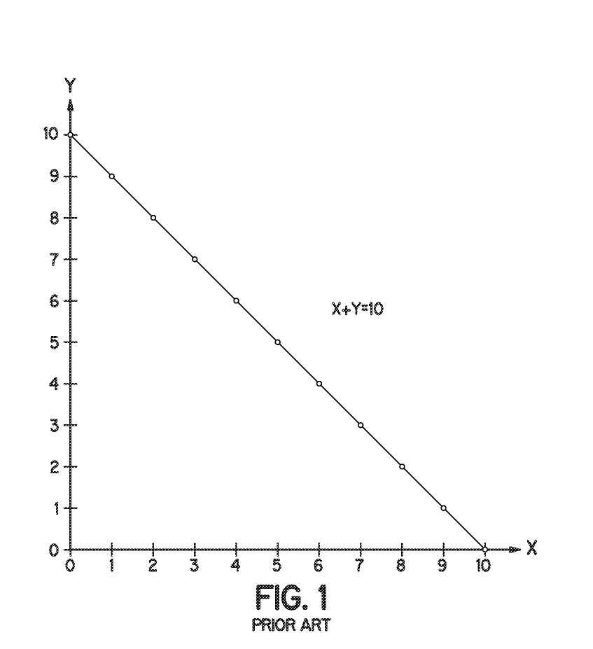

FIG. 2 illustrates a top plan view of a linear equation learning aid according to one embodiment;

FIG. 3 illustrates a top plan view of a plurality of markers used in the linear equation learning aid of FIG. 2 ranging in integer values from 1 to 10;

FIG. 4 illustrates a top plan view of a method of teaching linear equations to a student using the linear equation learning aid of FIG. 2.

### DETAILED DESCRIPTION OF THE DRAWINGS

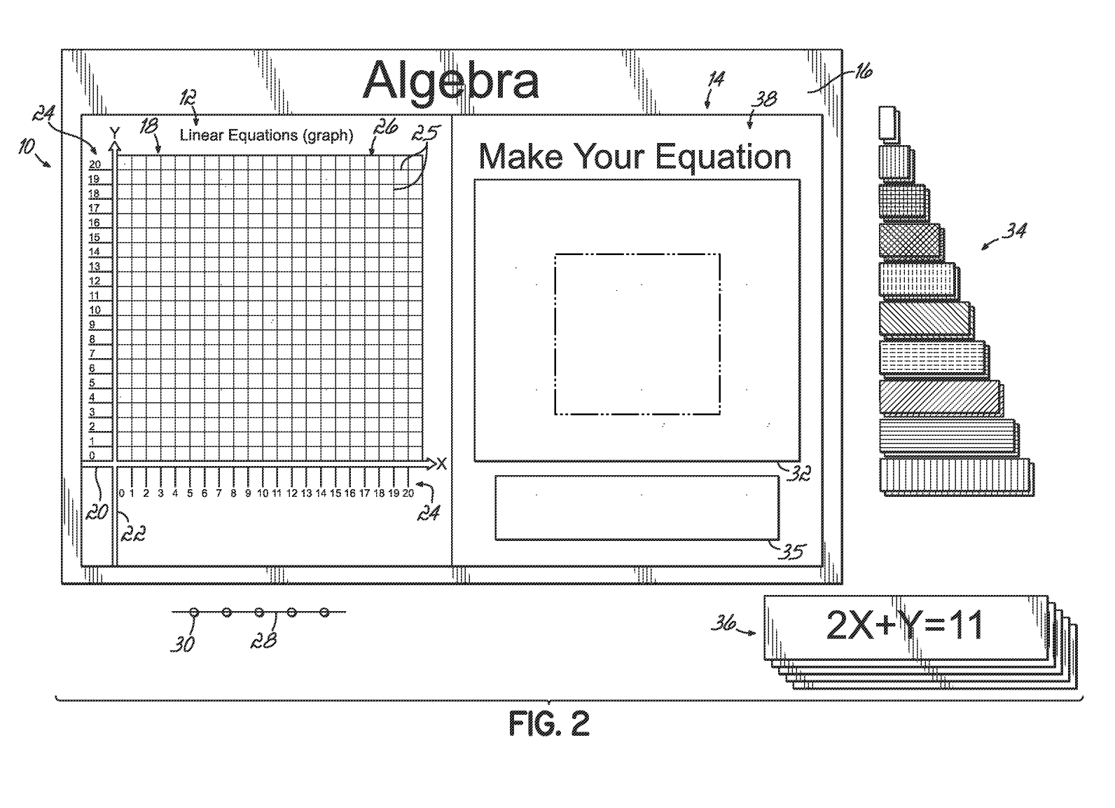

Referring now to FIG. 2, a learning aid 10 teaches linear equations using a combination of different visual and tactile sensory inputs. The learning aid 10 generally includes three main components. The first component is a first display 12 graphically representing the studied linear equation in a two-dimensional Cartesian coordinate plane. The learning aid 10 also includes a second display 14 graphically representing the linear equation using repeating one-dimensional graphs. In an exemplary embodiment, the first display 12 and the second display 14 are positioned on a substrate 16 side-by-side facilitating comparison of the two graphical representations. In one embodiment, the substrate 16 may be made of a cardboard material. However, those skilled in the art may recognize that other types of materials can be used in other embodiments. The first display 12 and the second display 14 can be made out of a soft material, such as felt, or a more rigid material, such as a laminated material, effective for allowing simple modifications to the displays during the learning process.

The first display 12 generally displays a graph 18. Graph 18 is a common Cartesian coordinate graph 18 in two dimensions labeled as X and Y in the illustrated embodiment. The first dimension of the graph 18 is the X-axis 20 and represents the X variable value in the linear equation. The second dimension of the graph 18 is the Y-axis 22 representing the value of the Y variable in the linear equation. The X-axis 20 and the Y-axis 22 intersect at zero and move perpetually away from each other in a positive direction toward infinity. Both the X-axis 20 and the Y-axis 22 have increments 24 along the axes 20, 22 that are denominated in integers in the illustrated embodiment. Those skilled in this art recognize that other intervals besides integer intervals can be used for increments 24 in other embodiments. The illustrated embodiment only depicts the linear equation and the positive integer values. Other embodiments could expand the graph 18 out into the negative integer valves. Similarly, an alternative embodiment could reposition the X-axis 20 or the Y-axis 22. In addition, extending parallel to the X-axis 20 and the Y-axis 22 along the increments 24 are lines 25 that form a grid 26. The grid 26 assists a student with accurate placing of points on the graph 18. Other embodiments may not use the lines 25 or the grid 26. A set of indicators, such as a fiber 28 and a plurality of fasteners 30 are positioned along the graph 18 representing the linear equation. The fasteners 30 are pushed into the graph 18 at points that correspond to the X and Y values in order to satisfy the equation. The fiber 28 may be removably attached to the fasteners 30 to connect them in a straight line or may be permanently attached to the fasteners 30 to provide an integral set. Connecting means other than a fiber 28 could also be used, such as a wire or any other flexible or inflexible member. Moreover, the fiber 28 or alternate connecting member need not be attached or attachable, but rather, need only be placeable along the fasteners 30. The fasteners 30 could be push-pins or a piece of felt with a Velcro® surface for example. Alternately, in place of fasteners 30, the set of indicators may simply include pieces of material with no attachment means that are placed onto the graph 18 as pointmarkers and connected in a line by any appropriate connecting member.

The second display 14 illustrates the linear equation using a series of one-dimensional graphical representations arranged generally parallel to one another. The second display 14 has a first placemat 32 upon which a plurality of indicators or markings 34 having varying lengths may be placed. In the illustrated embodiment, the first placemat 32 is a piece of felt and the markings 34 are also pieces of felt that are capable of being fixed to the first placemat 32, such as by using Velcro®. Other embodiments can use other types of materials, attach the markings 34 to the first placemat 32 using alternate methods, or even not attach the markings 34 at all.

The second display 14 also includes a second placemat 35 upon which an equation pad 36 may be placed. The equation pad 36 displays the equation under study. In the illustrated embodiment, the equation pad 36 is removable to facilitate studying different linear equations with the learning aid 1o. Placing a new equation pad 36 onto the learning aid 1o provides a new linear equation for representation. The markings 34 are rearranged along with the fiber 28 and fasteners 30 to reflect the relationship expressed in the new linear equation. The second display 14 also includes a space 38 that can depict a message. In the illustrated embodiment, the message depicted is to “Make Your Equation.” Other embodiments can use any other type of information to be placed upon space 38.

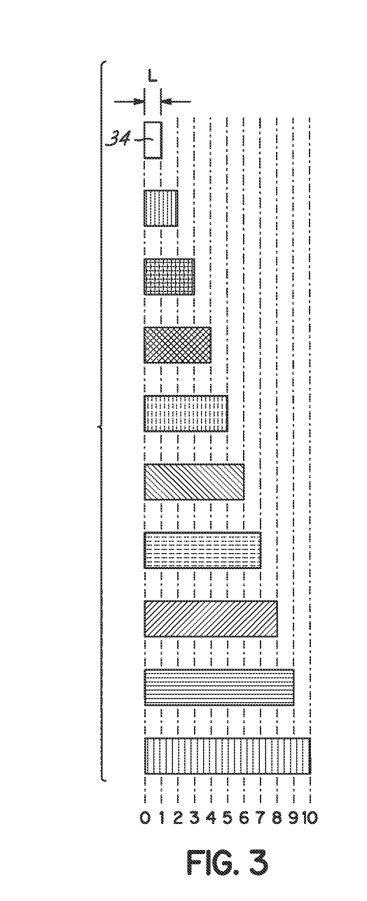

Referring now to FIG. 3, the plurality of markings 34 range in a length that corresponds to their value as an integer. Therefore, a marking 34 that has a length of L represents the integer “1.” The length of the markings 34 proportionately increases based on the values of the integers that they represent, for example L, 2L, 3L, 4L, etc. Moreover, in the illustrated embodiment, learning is further aided by the overlap of additional visual indicators to the learning aid 10. In the illustrated embodiment, each of the distinct integer values are associated with a particular color further adding to the student's visual sensory inputs. Alternatively, other embodiments can have a different visual cue such as stripes, dots, or other visual indicators. Furthermore, other embodiments could change the tactile feeling of the markings to improve understanding by the student. For example, a marking 34 having a low integer value could have a rougher tactile feel as compared to a larger integer value having a smoother tactile feel. Other methods of placing additional distinguishing features on the markings 34 are readily apparent to those skilled in this art.

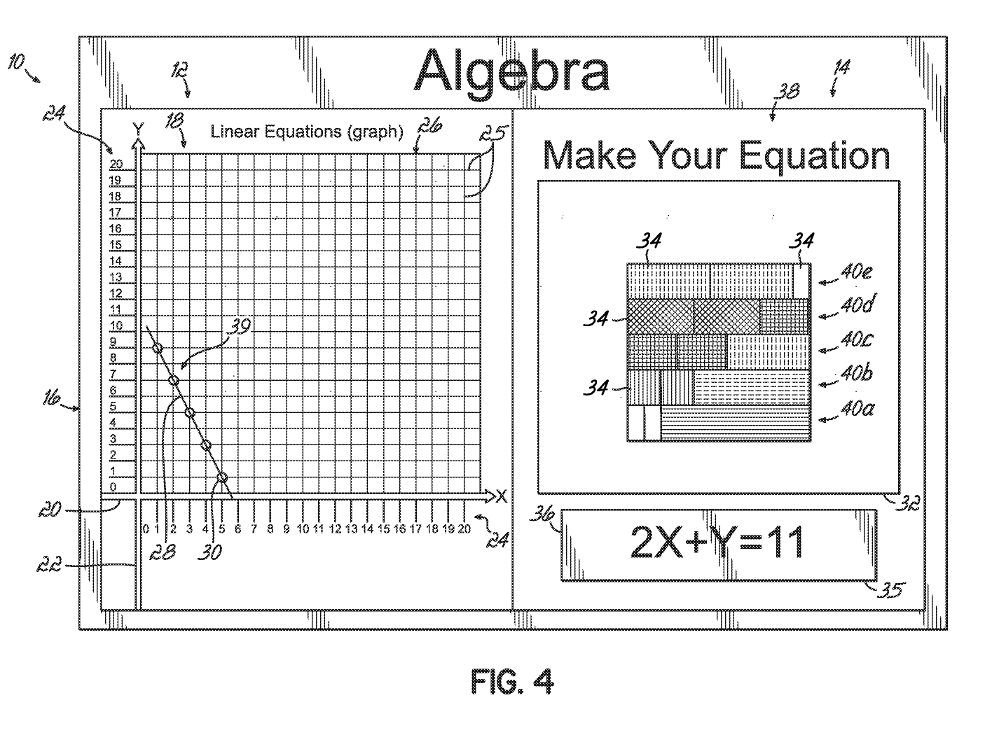

FIG. 4 illustrates how the learning aid 10 assists the student's understanding of linear equations. In operation, the learning aid 10 initially begins with placing an equation pad 36 onto second placemat 35 of the second display 14 noting the linear equation under study. Next, the student plugs different values of X and Y into the linear equation on the equation pad 36 that satisfy the equation. The student arranges the plurality of fasteners 30 and the fiber 28 to reflect the different values of X and Y. For example, in the illustrated embodiment, the linear equation is 2X+Y=11. When X equals one, then Y must equal nine to satisfy the equation. Accordingly, a fastener 30 is placed at the point on the grid 26 that represents an X axis value of “1” and a Y axis value of “9.” The fiber 28 connects all of these points between the fasteners 30 thereby providing a linear graphical description 39 of the equation along the graph 18. The removable nature of the fasteners 30 and the fiber 28 allow different linear equations to be graphed along the graph 18 as needed.

Similarly, the student obtains a plurality of markings 34 and arranges them into layers 40a, 40b, 40c, 40d, 40e on placemat 32, with each layer 40a-e representing a one-dimensional graphical illustration of the equation on the equation pad 36. For example, in the illustrated embodiment, the two small pieces for X in the bottom layer 40a illustrates X having an integer value of “1” to satisfy the 2× portion of the equation. The Y value is illustrated by the long marking 34 on the bottom layer 40a, corresponding to an integer value of “9.” On the next layer 40b, X increases to “2” (2×2) and therefore Y must decrease to “7.” In layer 40c, X then increases to “3” (2×3) and Y decreases to “5.” In layer 40d, X increases to “4” (2×4) and Y decreases to “3.” The process is complete for this equation in layer 40e when X increases to “5” (2×5) and Y decreases to “1.” Accordingly, using the markings 34 to form different layers 40a-e provides an additional method of teaching linear equations that appeals to both a tactile and visual learning. The tactile sensory input is very helpful as the student grips the markings 34 with their hands and physically moves the markings while exploring different permutations of the equations and values of X and Y. As a result, the different types of sensory inputs are stimulated.

One of the many advantages of the learning aid 10 is that the student can learn visually by looking simultaneously at the different displays 12, 14 thereby increasing understanding. The fiber 28 and fasteners 30 create one graphical representation of the linear equation. In addition, the second visual display 14 of the linear equation having a plurality of one-dimensional representations provides an alternative graphical representation of the linear equation. The physical learning aspect compounds these advantages by the student physically arranging the markings 34 and the indicators. Accordingly, supplementing the traditional lecture and textbook teaching method with the learning aid 10 will bolster the students' understanding of this challenging subject area.

While the present invention has been illustrated by description of various embodiments and while these embodiments have been described in considerable detail, it is not the intention of the applicant to restrict or in any way limit the scope of the claims to such detail. Additional advantages and modifications will readily appear to those skilled in the art. The claims in their broader aspect are, therefore, not limited to the specific details, representative system, apparatus, and method, and illustrative example shown and described. Accordingly, the following claims alone solely define the invention.

What is claimed is:

1. A kit for teaching linear equations comprising:
a substrate having a first display and a second display, wherein the first display includes a two-dimensional Cartesian graph, wherein the second display includes a placemat;
a set of indicators adapted to be placed on the two-dimensional Cartesian graph to graphically illustrate the linear equation on the two-dimensional Cartesian graph; and
a set of markers each having a length corresponding to a numerical value, wherein the set of markers are adapted to be on the placemat in a position to illustrate the linear equation in one dimension.

2. The kit of claim 1 wherein the set of indicators includes a fiber and a plurality of fasteners.

3. The kit of claim 1 wherein the set of markers has a predetermined set of colors with each color corresponding to a certain marker length.

4. The kit of claim 1 wherein the first display and the second display are arranged side-by-side on the substrate.

5. A method for teaching linear equations using a learning aid comprising:
arranging a first set of indicators to graphically represent a linear equation in two mathematical dimensions on a first display; and
arranging a second set of indicators representing a constant numerical value on a second display, wherein arrangement of the second set of indicators graphically corresponds with the linear equation in one dimension, wherein both graphical representations on the first display and the second display are displayed simultaneously on a substrate.

6. The method of claim 5 wherein the first set of indicators and the second set of indicators are positioned on the substrate side-by-side.

7. The method of claim 5 wherein the second set of indicators represents an integer numerical value from one to ten.

8. The method of claim 7 wherein the second set of indicators are proportional in length to their respective numerical values.

9. The method of claim 7 wherein the second set of indicators has a predetermined set of colors corresponding to their respective numerical values.

10. The method of claim 5 wherein the first set of indicators are a fiber and fasteners.

11. A device for teaching linear equations comprising:
a substrate including a first display and a second display;
a first graphical representation of the linear equation located on the first display, the first graphical representation including a line placed on a two-dimensional Cartesian coordinate graph;
a second graphical representation of the linear equation positioned side-by-side to the first graphical representation on the second display, the second graphical representation including markers having a length representative of an numerical value, the markers arranged linearly to represent the linear equation.

12. The device of claim 11 wherein each marker having a certain length has a certain color associated with that length.

13. The device of claim 11 wherein the line is formed using a fiber and fasteners.

14. The device of claim 11 wherein the graphical representations are made using physical objects.

15. The device of claim 11 wherein the graphical representations can be changed to illustrate differing linear equations.
